(19) United States
(12) Patent Application Publication
(10) Pub. No.: US 2020/0080356 A1
(43) Pub. Date: Mar. 12, 2020

(54) CABINET DOOR MOUNTING STRUCTURE AND CABINET HAVING SAME

(71) Applicant: Goldtek Technology Co., Ltd., New Taipei City (TW)

(72) Inventor: WU-HUNG YANG, New Taipei (TW)

(21) Appl. No.: 16/410,048

(22) Filed: May 13, 2019

(30) Foreign Application Priority Data
Sep. 12, 2018 (TW) 107132147

(51) Int. Cl. E05D 3/02; E05D 15/58; E06B 3/50

(52) U.S. Cl. CPC E05D 3/02; E05Y 2900/20; E06B 3/5045; E05D 15/582

(57) ABSTRACT

A cabinet door mounting structure for detachably mounting a cabinet door to a cabinet body includes a mounting base, a mounting post, and a mounting plate. The mounting base defines a latching slot. The mounting post extends from the mounting base and is configured to rotationally couple the cabinet door to the cabinet body. The mounting plate is fixedly coupled to the cabinet door. The mounting plate is configured to be bent to latch the mounting plate in the latching slot to mount the cabinet door to the mounting base.

### FIELD

The subject matter herein generally relates to cabinets, and more particularly to a cabinet door mounting structure for mounting a cabinet door to a cabinet body.

### BACKGROUND

Existing cabinets, such as logistics cabinets, generally have cabinet doors welded or hinge-screwed onto a cabinet body for opening and closing the cabinet. However, assembly and disassembly of such cabinets may be cumbersome.

### BRIEF DESCRIPTION OF THE DRAWINGS

Implementations of the present disclosure will now be described, by way of embodiments, with reference to the attached figures.

FIG. 1 is an assembled, isometric view of an embodiment of a cabinet including a cabinet door mounting structure.

FIG. 2 is a close-up view of a mounting base of the cabinet door mounting structure.

FIG. 3 is a schematic view of a cabinet door and the cabinet door mounting structure.

FIG. 4 is a schematic view of the mounting base coupled to the cabinet door.

FIG. 5 is a schematic view of the mounting base locked to the cabinet door.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

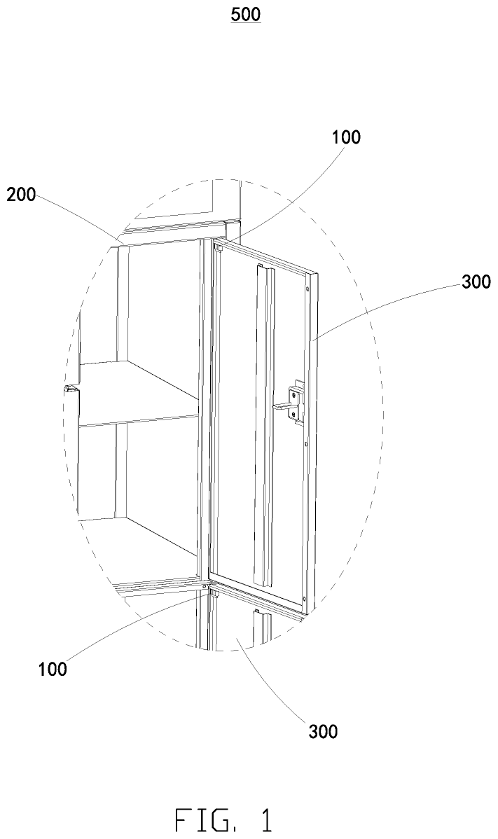

FIG. 1 shows an embodiment of a cabinet 500 including a cabinet body 200, a cabinet door 300, and a cabinet door mounting structure 100.

The cabinet 500 may include one or more cabinet doors 300. Each cabinet door is correspondingly mounted with one cabinet door mounting structure 100. For convenience of explanation, a structure and working principle of the cabinet door mounting structure 100 will be described below by taking one cabinet door 300 as an example.

One end of the cabinet door 300 is rotationally coupled to the cabinet body 200 through a positioning shaft (not shown). Another end of the cabinet door 300 is detachably mounted to the cabinet body 200 by the cabinet door mounting structure 100.

For example, a bottom end of the cabinet door 300 defines a positioning hole (not shown), and the cabinet body 200 includes the rotating shaft corresponding to the rotation hole. The cabinet door 300 is placed in a position to align the positioning shaft with the positioning hole, and the positioning shaft is inserted into the positioning hole under gravity of the cabinet door 300. A top end of the cabinet door 300 is detachably mounted to the cabinet body 200 by the cabinet door mounting structure 100.

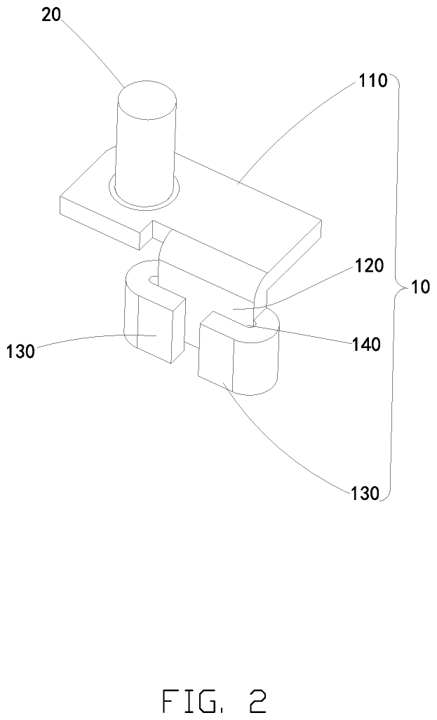

Referring to FIGS. 2-5, the cabinet door mounting structure 100 includes a mounting base 10, a mounting post 20, and a mounting plate 30.

The mounting base 10 defines a latching slot 140.

One end of the mounting post 20 is fixedly coupled to the mounting base 10. A second end of the mounting post 20 is configured to insert through a rotating hole 301 defined in the cabinet door 300. The cabinet body 200 defines an insertion hole (not shown). When the rotating hole 301 is aligned with the insertion hole, the mounting post 20 is inserted sequentially through the rotating hole 301 and the insertion hole to rotationally couple the mounting base 10 to the cabinet body 200.

The mounting plate 30 is fixedly coupled to the cabinet door 300.

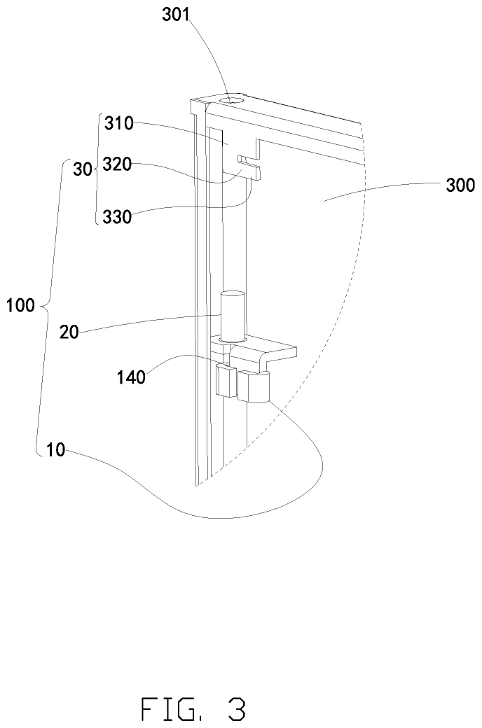

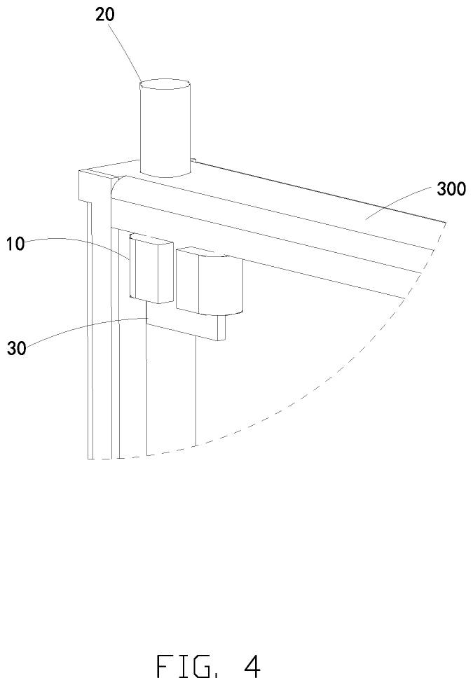

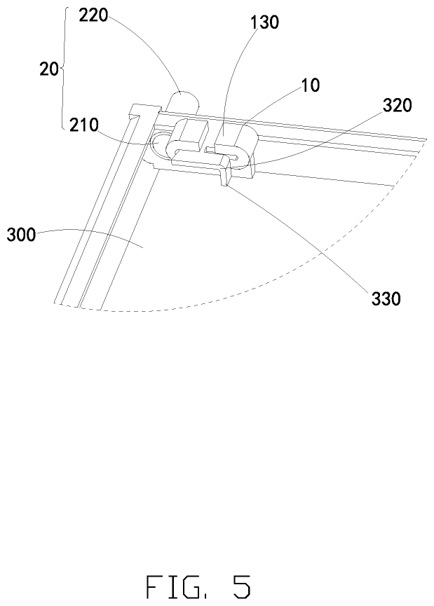

The mounting plate 30 includes a stopping portion 330 configured to latch with the latching slot 140. The stopping portion 330 is bendable between a stop position (shown in FIG. 5) and a release position (shown in FIG. 3 and FIG. 4).

When the stopping portion 330 is in the release position, the mounting plate 30 is able to slide within the latching slot 140. Thus, a distal end of the mounting plate 30 is free to slide within the latching slot 140 without being stopped by the stopping portion 330.

When the mounting plate 30 passes through the latching slot 140 and the stopping portion 330 is bent to the stop position, the stopping portion 330 abuts against one side of the mounting base 10. Thus, the cabinet door 300 is mounted to the mounting base 10.

When the cabinet door 300 is installed with one end of the mounting plate 30, the stopping portion 330 may be first bent to the release position, and at this time, the free end of the mounting plate 30 may be at the card. The groove 140 slides inside.

To mount the cabinet door 300 to the cabinet body 200, the bottom end of the cabinet door 300 is first mounted to the cabinet body 200 by inserting the positioning shaft through the positioning hole under gravity of the cabinet door 300. Then, the rotating hole 301 of the cabinet door is aligned with the insertion hole of the cabinet body 200. Then, the mounting base 10 is moved until the mounting plate 30 passes through the latching slot 140. Finally, the stopping portion 330 is bent to the stop position, thereby mounting the cabinet door 300 to the mounting base 10.

To disassemble the cabinet door 300 from the cabinet body 200, the stopping portion 300 is bent from the stop position to the release position. Then, the mounting base 10 is moved away from the mounting plate 30 to remove the stopping portion 330 out of the latching slot 140 and remove the mounting post 20 out of the insertion hole and the rotating hole 301. Thus, the cabinet door 300 can be disassembled from the cabinet body 200.

In one embodiment, the mounting plate 30 includes a connecting portion 310, a stopping portion 330, and a bent portion 320.

The connecting portion 310 is fixedly coupled to the cabinet door 300.

The stopping portion 330 is coupled to the connecting portion 310 by the bent portion 320.

When the stopping portion 330 is pulled by an external force, the bent portion 320 is deformed to bend the stopping portion 330 between the stop position and the release position.

In one embodiment, as shown in FIG. 3, the connecting portion 310, the stopping portion 330, and the bent portion 320 are an integrally formed structure.

When the stopping portion 330 is bent to the release position, the connecting portion 310, the stopping portion 330, and the bent portion 320 are coplanar with each other, so that the mounting plate 30 can freely slide through the latching slot 140.

When the stopping portion 330 is bent to the stop position, the stopping portion 330 forms an angle with the connecting portion 310, so that the stopping portion 330 stops the mounting plate 30 from sliding through the latching slot 140, and the mounting plate 30 is locked to the mounting base 10.

In one embodiment, as shown in FIG. 2, the mounting base 10 includes a connecting plate 110, a side plate 120, and a locking plate 130.

In one embodiment, as shown in FIG. 5, the mounting post 20 includes a fixed end 210 and an extended end 220. The fixed end 210 is fixedly coupled to the connecting plate 110. The extended end 220 is inserted through the rotating hole 301 and the insertion hole.

The side plate 120 is coupled substantially perpendicularly to one side of the connecting plate 110.

The locking plate 130 is coupled to the side plate 120. The latching slot 140 is defined between the locking plate 130 and the side plate 120.

In one embodiment, the mounting base 10 includes two locking plates 130. The two locking plates 130 are respectively coupled to opposite sides of the side plate 120 and curved around to a same side of the side plate 120 to define the latching slot 140.

The cabinet door mounting structure 100 has a simple structure and provides convenient mounting and disassembly of the cabinet door 300 and the cabinet body 200.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A cabinet door mounting structure for detachably mounting a cabinet door to a cabinet body, the cabinet door mounting structure comprising:
a mounting base defining a latching slot;
a mounting post extended from the mounting base and configured to rotationally couple the cabinet door to the cabinet body; and
a mounting plate fixedly coupled to the cabinet door; wherein:
the mounting plate is configured to be bent to latch the mounting plate in the latching slot to mount the cabinet door to the mounting base.

2. The cabinet door mounting structure of claim 1, wherein:
the mounting plate comprises a connecting portion, a stopping portion, and a bent portion;
the connecting portion is coupled to the cabinet door;
the stopping portion is coupled to the connecting portion by the bent portion;
the bent portion is configured to be bent by an external force to bend the stopping portion between a stop position and a release position;
the stopping portion is bendable between a stop position and a release position;
when the stopping portion is in the release position, the mounting plate is able to slide within the latching slot;
when the mounting plate passes through the latching slot and the stopping portion is bent to the stop position, the stopping portion abuts against one side of the mounting base to mount the cabinet door to the mounting base.

3. The cabinet door mounting structure of claim 2, wherein:
the connecting portion, the bent portion, and the stopping portion are an integrally formed structure;
when the stopping portion is in the release position, the connecting portion, the bent portion, and the stopping portion are coplanar with each other;
when the stopping portion is bent to the stop position, the stopping portion forms an angle with the connecting portion.

4. The cabinet door mounting structure of claim 2, wherein:
the mounting base comprises a connecting plate, a side plate, and at least one locking plate;
one end of the mounting post is fixedly coupled to the connecting plate;
the side plate is perpendicularly coupled to the connecting plate;
the at least one locking plate is coupled to a side of the side plate;
the latching slot is defined between the at least one locking plate and the side plate.

5. The cabinet door mounting structure of claim 4, wherein:
the mounting plate comprises two locking plates;
the two locking plates are respectively coupled to opposite sides of the side plate and curved around to a same side of the side plate to define the latching slot with the side plate.

6. A cabinet comprising:
a cabinet body;
a cabinet door; and
a cabinet door mounting structure; wherein:
one end of the cabinet door is rotationally coupled to the cabinet body, and another end of the cabinet door is detachably mounted to the cabinet body by the cabinet door mounting structure.

7. The cabinet of claim 6, wherein:
the cabinet door mounting structure comprises a mounting base, a mounting post, and a mounting plate;
the mounting base defines a latching slot;
the mounting post extends from the mounting base and is configured to rotationally couple the cabinet door to the cabinet body;
the mounting plate is fixedly coupled to the cabinet door;
the mounting plate is configured to be bent to latch the mounting plate in the latching slot to mount the cabinet door to the mounting base.

8. The cabinet of claim 7, wherein:
the cabinet door defines a rotating hole;
the mounting post is inserted through the rotating hole to rotationally couple the cabinet door to the cabinet body.

9. The cabinet of claim 8, wherein:
the mounting plate comprises a connecting portion, a stopping portion, and a bent portion;
the connecting portion is coupled to the cabinet door;
the stopping portion is coupled to the connecting portion by the bent portion;
the bent portion is configured to be bent by an external force to bend the stopping portion between a stop position and a release position;
the stopping portion is bendable between a stop position and a release position;
when the stopping portion is in the release position, the mounting plate is able to slide within the latching slot;
when the mounting plate passes through the latching slot and the stopping portion is bent to the stop position, the stopping portion abuts against one side of the mounting base to mount the cabinet door to the mounting base.

10. The cabinet of claim 9, wherein:
the connecting portion, the bent portion, and the stopping portion are an integrally formed structure;
when the stopping portion is in the release position, the connecting portion, the bent portion, and the stopping portion are coplanar with each other;
when the stopping portion is bent to the stop position, the stopping portion forms an angle with the connecting portion.

11. The cabinet of claim 10, wherein:
the mounting base comprises a connecting plate, a side plate, and at least one locking plate;
one end of the mounting post is fixedly coupled to the connecting plate;
the side plate is perpendicularly coupled to the connecting plate;
the at least one locking plate is coupled to a side of the side plate;
the latching slot is defined between the at least one locking plate and the side plate.

12. The cabinet of claim 11, wherein:
the mounting plate comprises two locking plates;
the two locking plates are respectively coupled to opposite sides of the side plate and curved around to a same side of the side plate to define the latching slot with the side plate.
